(19) United States
(12) Patent Application Publication
(10) Pub. No.: US 2023/0274278 A1
(43) Pub. Date: Aug. 31, 2023

(54) ADAPTABLE MESSAGING

(71) Applicant: MasterCard International Incorporated, Purchase, NY (US)

(72) Inventors: Patrik Smets, Nijlen (BE); Jonathan James Main, Hampshire (GB); Mehdi Collinge, Mont-Sainte-Aldegonde (BE)

(21) Appl. No.: 18/142,708

(22) Filed: May 3, 2023

Related U.S. Application Data
(63) Continuation of application No. 14/881,249, filed on Oct. 13, 2015.

(51) Int. Cl. G06Q 20/40; G06Q 20/36; G06Q 20/32; G06Q 20/38

(52) U.S. Cl. CPC G06Q 20/4014; G06Q 20/40; G06Q 20/367; G06Q 20/3227; G06Q 20/322; G06Q 20/382; G06Q 2220/00

(57) ABSTRACT

Methods, apparatus and systems for operating a payment-enabled mobile device to facilitate a payment transaction with a merchant server. In an embodiment, a mobile device processor of the payment-enabled mobile device receives a payment transaction request from a user, transmits a payment transaction initiation message directly to a merchant server of the merchant, and receives a request message from the merchant server that includes one of a request to provide an Authorization Request Cryptogram (ARQC) or a request to provide user consent information. The user consent information may include cardholder verification results or a request to provide an ARQC. Based on the received request message, the mobile device processor selects a particular mobile payment cardlet to use from a plurality of mobile payment cardlets running in a secure element, generates remote payment data using the particular mobile payment cardlet, and transmits the remote payment data to the merchant server to process the payment transaction.

### CROSS-REFERENCE TO RELATED APPLICATION

This application is a U.S. Continuation Patent Application of U.S. patent application Ser. No. 14/881,249 filed on Oct. 13, 2015, the entire contents of which are incorporated herein by reference for all purposes.

### BACKGROUND

It is increasingly common for consumers to make purchases using devices such as mobile phones or the like. These remote purchase transactions pose challenges to financial institutions and other entities. For example, these transactions present challenges related to the authentication of users and other fraud related matters. A number of approaches have been proposed to improve user authentication and to reduce fraud in remote transactions. For example, one desirable approach is to utilize the authentication and security features provided by the EMV Standards (at www.emvco.con) in remote transactions. However, not all online or remote merchant systems support these standards. It would be desirable to provide systems and methods that allow remote transactions from a browser, on mobile devices, in-application or the like to provide a good user experience while reducing fraud.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, which illustrate preferred and exemplary embodiments and which are not necessarily drawn to scale, wherein:

FIG. 1 is a block diagram that illustrates a system in which the present invention may be applied.

FIG. 2 is a block diagram that illustrates an example embodiment of a payment-enabled smartphone provided in accordance with aspects of the present invention.

FIG. 3 is an information flow diagram showing functional software blocks provided in the smartphone of FIG. 2 in accordance with aspects of the present invention.

FIG. 4 is a flow chart that illustrates a process that may be performed in the smartphone of FIG. 2 according to aspects of the present invention.

### DETAILED DESCRIPTION

Embodiments of the present invention provide systems, methods, apparatus and computer programming code for operating a device to complete a transaction. Embodiments are described herein which include receiving a request to initiate a transaction with a merchant, transmitting a payment transaction initiation message to a merchant server associated with the merchant, receiving a request message from the merchant server for remote payment data, the request message including information identifying whether the merchant server supports a selected one of a first data format and an alternative data format, and providing the remote payment data to the merchant server in the selected data format for use by the merchant server to initiate authorization processing of the transaction.

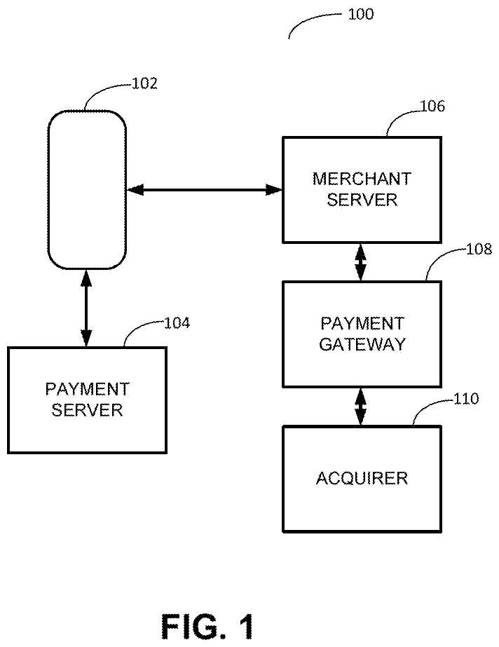

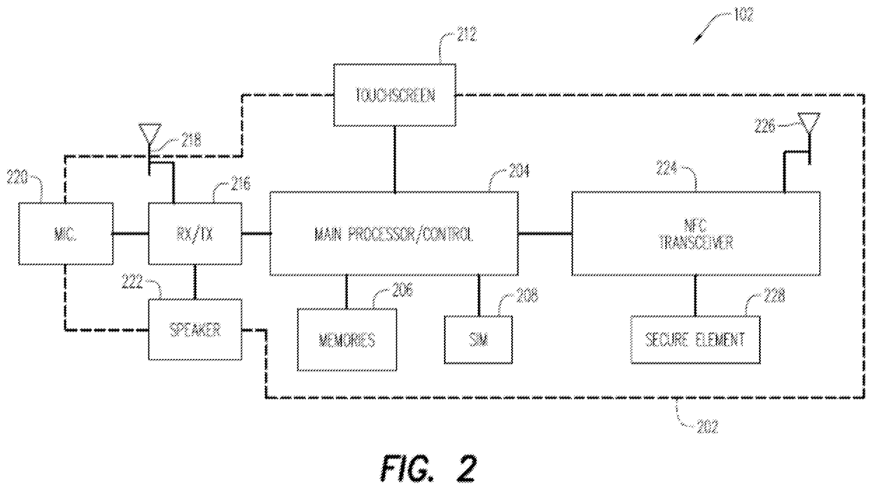

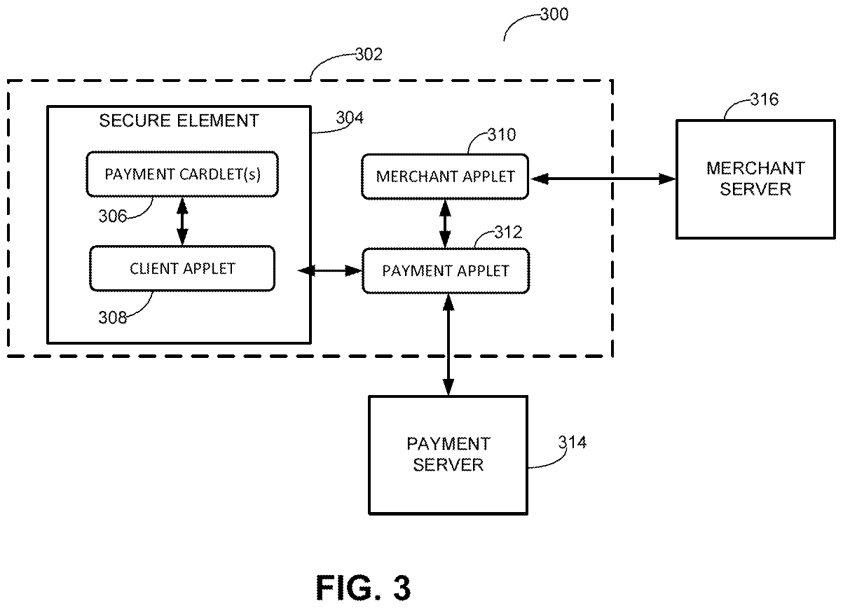

FIG. 1 is a block diagram that illustrates a system 100 in which the present invention may be applied. For illustrative purposes, features of the present invention will be described in the context of use of a payment enabled mobile device 102, however, those skilled in the art will appreciate that features of the present invention may be used with desirable results in transactions involving other devices as well (such as tablet or other computing devices). As shown, the system 100 includes a payment-enabled mobile device 102. The mobile device 102 may be operable as a mobile telephone, while also being able to perform functions of a contactless payment card as provided in accordance with aspects of the present invention and as described below. Further details of the mobile device 102 are described below in conjunction with FIGS. 2-3.

As shown, the system 100 further includes a merchant server 106 in communication with the mobile device 102. Although only a single mobile device 102 and merchant server 106 are depicted, the system 100 likely involves a multitude of both devices. For example, a number of consumers operating a number of mobile devices 102 may interact with a variety of different merchants operating merchant servers 106 to facilitate transactions pursuant to the present invention. An interaction between a mobile device 102 and a merchant server 106 may be, for example, a wireless interaction over a network interface. For example, a mobile device 102 may interact with a merchant server 106 to conduct a purchase transaction over a mobile telephone communication network using a protocol such as HTTP (HyperText Transfer Protocol) or the like. In some embodiments, the communication between the mobile device 102 and the merchant server 106 may be facilitated or controlled via a mobile application installed on the mobile device 102 (e.g., such as, for example, a merchant application on the mobile device).

Pursuant to some embodiments, the mobile device 102 may conduct transactions with the merchant server 106 from a browser on the mobile device 102 or from an application on the mobile device 102 which interacts with a payment server 104 (which may also be referred to herein as a “wallet server”). The mobile device 102 may store information associated with one or more payment wallets which correspond to one or more wallets on the wallet server. Pursuant to some embodiments, transactions are processed using a secure payment protocol which may be referred to herein as “Digital Secure Remote Payment” (DSRP) which provides improved fraud prevention (which, in some embodiments, may allow reduced fraud liability for the merchant). As will be described, embodiments provide a number of benefits including, for example, a better user experience for users conducting transactions using a mobile device 102, a variety of mobile specific use-cases (such as in-aisle shopping or the like), a potential liability shift (from the merchant and user perspective), and improved user authentication.

Features of transactions pursuant to some embodiments will now be described by reference to the components of FIG. 1. In general, a transaction may be initiated by a user operating a mobile device 102, e.g., by initiating a request to purchase a good or service from a merchant (e.g., from within an application or browser of the mobile device 102 while in communication with a merchant). The merchant server 106 associated with the merchant communicates with the mobile device 102 to request that a merchant application of the mobile device 102 (as shown in FIG. 3) perform a payment transaction. Included in the request is information identifying the type of data format supported by the merchant server 106. For example, as used herein, embodiments will be described in which a merchant server may support (or be configured to support for particular transactions) a “first data format” or an “alternative data format”. In some embodiments, multiple data formats may be used. For example, some embodiments will be described herein which utilize a “first data format’, “a second data format” and a “third data format’. As used herein, the term “alternative data format” or “second data format” generally refers to a format other than the “first data format”, such as a “second data format”, a “third data format” or other variations.

As a specific example, the first data format may be a data format that supports a full data cryptogram pursuant to the EMV standards (available at http://www.emvco.com the contents of which are hereby incorporated by reference in their entirety for all purposes). If the merchant server 106 indicates it supports the first data format, in some embodiments, the merchant server 106 is capable of receiving an EMV Authorization Request Cryptogram (ARQC) returned in Data Element 55 (“DE 55”) of the EMV Integrated Circuit Card (ICC) System-Related Data, and is generated using the full set of inputs for the ARQC generation pursuant to the EMV standards. If the merchant server 106 is capable of receiving a message in the first data format, the cryptogram may be validated using a standard EMV authorization host system.

If the merchant server 106 does not support messages in the first data format, it will support messages in an alternative data format. For example, in some embodiments, a different data format (e.g., an “alternative data format”, “second data format” or a “third data format”) may be used for transactions where some counter information needs to be carried as part of the authorization transaction. In this case, the ARQC is generated using a partial set of the inputs that are available. That is, some fields are set to default values rather than values specific to the transaction. The ARQC and associated EMV data is compressed (for example, static values based on the defaults are removed and a bit map coding may be used) and packaged in a standard message field such as the “UCAF” field. In order to validate the cryptogram, the value in the UCAF (or other standard message field) must be converted back into a first data format (e.g., the DE 55 format) by adding the default and the static values. This may be performed as a pre-processing step by the issuer authorizing the transaction or by a stand in processing entity. The converted value may then be validated by a standard authorization host system (e.g., such as the issuer or a stand in entity).

In some embodiments, if the merchant server 106 does not support messages in the first data format, it may support messages in a different data format (e.g., an “alternative data format, a “second data format’ or a “third data format”). For example, an alternative data format may be used in transactions which require, or benefit from, the inclusion of additional information about user consent and user authentication to the authorization system.

In this manner, embodiments allow transactions to be performed between a mobile device 102 and different merchant servers 106, including merchant servers 106 that are not capable or configured to receive full EMV format messages. As a result, merchant servers 106 which are only capable of or configured to process normal payment transactions can enjoy the benefit of increased fraud protection of EMV in remote payment transactions.

Depending on the nature of the response from the merchant server 106 (regarding whether it supports a first data format or an alternative data format), the mobile device 102 generates remote payment data for transmission to the merchant server 106 to process the transaction. Details of the generation of the remote payment data will be provided below in conjunction with FIG. 3. In general, the remote payment data format will depend on whether the merchant server 106 supports a first data format or an alternative data format. The merchant server 106 packages the remote payment data in an authorization response for transmission to an acquirer 110 (which may be transmitted via a payment gateway 108). The authorization request, response and clearing will then be processed between the merchant server 106 (and/or the payment gateway 108 if one is involved) the payment server 104 and the issuer of the payment instrument used in the transaction. In some embodiments, the processing between these entities may be different depending on whether the merchant server 106 supported the first data format or an alternative data format.

For example, if the merchant server 106 supported the first data format, the remote payment data received from the mobile device 102 is contained in a standard EMV ARQC in Data Element 55 of a remote payment message, and the system will process the transaction using standard EMV processing to validate the ARQC. However, if the merchant server 106 did not support (or was not configured to support) the first data format, the remote payment message is received in the alternative data format and the ARQC is generated from a partial set of the inputs available, and the ARQC and associated EMV data is compressed (for example, static values based on the defaults are removed and a bit map coding may be used) and received by the merchant server 106 in a standard payment transaction message field such as the “UCAF” field. In such embodiments the system rebuilds or reconstructs a DE 55 field from the received data. This rebuilding is performed before performing its regular mapping processing. The rebuilding may consist of a process such as: (1) adding a tag length to the data received from the UCAF field, (2) adding the defaulted data to the reconstructed DE 55 field, and (3) extracting the payment account number (“PAN”) from the payment transaction message (e.g., by retrieving it from a standard transaction message field such as DE2) and adding it to the reconstructed DE 55 field in field “5A” (the EMV “Application Primary Account Number (PAN)” field) as well as in field “5F34” (the EMV “Application Primary Account Number (PAN) Sequence Number” field). In this way, merchant servers 106 that do not (or are not configured to) process standard EMV messages may be adapted to process such messages.

A computer 110 operated by an acquirer (acquiring financial institution) is also shown as part of the system 100 in FIG. 1. The acquirer computer 110 may operate in a conventional manner to receive an authorization request for the transaction from the merchant server 106. The acquirer computer 110 may route the authorization request via a payment network (not show) to a server computer or other system operated by or on behalf of the issuer of a payment card account that is available for access by the mobile device 102 and that has been selected for use in the present payment transaction. Also in a conventional manner, the authorization response generated by the payment card issuer may be routed back to the merchant server 106 via the payment network and the acquirer computer 110.

The payment network may be entirely or substantially conventional; one example of a suitable payment network is the well-known Banknet system operated by MasterCard International Incorporated, which is the assignee hereof.

The systems or computers operated by or on behalf of the issuer of the payment card used in the transaction may be conventional and may be operated by or on behalf of a financial institution (“FI”; not separately shown) that issues payment card accounts to individual users. For example, the systems or computers operated by or on behalf of the payment card issuer may perform conventional functions, such as (a) receiving and responding to requests for authorization of payment card account transactions to be charged to payment card accounts issued by the FI; and (b) tracking and storing transactions and maintaining account records.

The components of the system 100 as depicted in FIG. 1 are only those that are needed for processing a single transaction. A typical practical embodiment of the system 100 may process many purchase transactions (including simultaneous transactions) and may include a considerable number of payment card issuers and their computers, a considerable number of acquirers and their computers, and numerous merchants and their merchant servers and associated components. The system may also include a very large number of payment card account holders, who carry payment-enabled mobile devices 102 and/or payment cards (including contactless payment cards and/or magnetic stripe cards).

It should also be understood that the mobile device 102 is operable as a conventional mobile telephone for communication—both voice and data—over a conventional mobile telecommunications network, which is not depicted in the drawing. Thus, the mobile device 102 may be in communication from time to time in a conventional manner with a mobile network operator (“MNO”—also not shown). An over-the air communication channel (not shown in FIG. 1) between the mobile device 102 and a payment card issuer server computer (or a related computer, neither shown in FIG. 1) may be established from time to time for purposes such as personalization, set up, etc. with respect to the mobile device 102.

FIG. 2 is a block diagram that illustrates an example embodiment of the payment-enabled mobile device 102 shown in FIG. 1 and provided in accordance with aspects of the present invention. The mobile device 102 may be conventional in its hardware aspects. For example, the mobile device 102 may resemble, in most of its hardware aspects and many of its functions, a conventional “iPhone” marketed by Apple Inc., or one of the numerous smartphone models that run the “Android” operating system.

The mobile device 102 may include a conventional housing (indicated by dashed line 202 in FIG. 2) that contains and/or supports the other components of the mobile device 102. The housing 202 may be shaped and sized to be held in a user's hand, and may, for example, exhibit the type of form factor that is common with the current generation of mobile devices.

The mobile device 102 further includes conventional control circuitry 204, for controlling over-all operation of the mobile device 102. For example, the control circuitry 204 may include a conventional processor of the type designed to be the “brains” of a mobile device.

Other components of the mobile device 102, which are in communication with and/or controlled by the control circuitry 204, include: (a) one or more memory devices 206 (e.g., program and working memory, etc.); (b) a conventional SIM (subscriber identification module) card 208; (c) a conventional touchscreen 212 which serves as the primary input/output device for the mobile device 102, and which thus receives input information from the user and displays output information to the user. As is the case with many models of mobile device, in some embodiments the mobile device 102 may also include a few physically-actuatable switches/controls (not shown), such as an on/off/reset switch, a menu button, a “back” button, a volume control switch, etc. It may also be the case that the smartphone includes a conventional digital camera, which is not shown.

The mobile device 102 also includes conventional receive/transmit circuitry 216 that is also in communication with and/or controlled by the control circuitry 204. The receive/transmit circuitry 216 is coupled to an antenna 218 and provides the communication channel(s) by which the mobile device 102 communicates via the mobile telephone communication network (not shown). The receive/transmit circuitry 216 may operate both to receive and transmit voice signals, in addition to performing data communication functions.

The mobile device 102 further includes a conventional microphone 220, coupled to the receive/transmit circuitry 216. Of course, the microphone 220 is for receiving voice input from the user. In addition, a loudspeaker 222 is included to provide sound output to the user, and is coupled to the receive/transmit circuitry 216.

The receive/transmit circuitry 216 may operate in a conventional fashion to transmit, via the antenna 218, voice signals generated by the microphone 220, and to reproduce, via the loudspeaker 222, voice signals received via the antenna 218. The receive/transmit circuitry 216 may also handle transmission and reception of text messages and other data communications via the antenna 218.

The mobile device 102 may also include circuitry 224 that is partly or wholly dedicated to implementing the NFC communications circuitry functionality of the mobile device 102. The mobile device 102 may further include a loop antenna 226, coupled to the NFC circuitry 224. In some embodiments, the NFC circuitry 224 may partially overlap with the control circuitry 204 for the mobile device 102. Moreover, the payment circuitry is associated with, and may also overlap with, a secure element 228 that is part of the mobile device 102 and is contained within the housing 202, or the NFC circuitry could be omitted in embodiments that do not utilize NFC. The term “secure element” is well known to those who are skilled in the art, and typically refers to a device that may include a small processor and volatile and nonvolatile memory (not separately shown) that are secured from tampering and/or reprogramming by suitable measures.

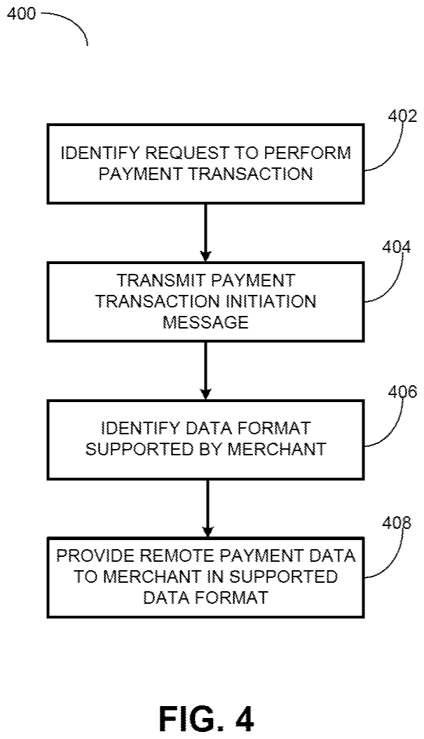

Further details relating to the secure element 228, and particularly relating to the programming thereof, will be described below with reference to FIGS. 3 and 4. In some embodiments, the secure element 228 may be provided as part of the SIM card 208. In other embodiments, the secure element 228 may be constituted by an integrated circuit card separate from the SIM card 208 but possibly having the same form factor as the SIM card 208. In some embodiments of the mobile device 102, the secure element 228 may be conventional in its hardware aspects but may be programmed in accordance with aspects of the present invention in a manner to be described below. In some embodiments, the term “secure element” is not intended to be limited to devices that are IC-based, but rather may also include any secure execution environment in a mobile device, and may include software based secure execution environments running on the main mobile device processor.

FIG. 3 is an information flow diagram showing functional software blocks provided in the mobile device 102 in accordance with aspects of the present invention. The dotted-line block 302 in FIG. 3 schematically represents the housing 202 of the smartphone 102 in the sense that software and hardware components represented in the block 302 are features of the mobile device 102. The block 304 represents the secure element 228 referred to above in FIG. 2 and is labeled accordingly.

In accordance with aspects of the present invention, the secure element 228 has stored therein a plurality of mobile payment cardlets (payment card applications) 306. Although only a single mobile payment cardlet 306 is explicitly shown in FIG. 3, the number actually present in the secure element 228/smartphone 102 may be greater than that. As is conventional, each of the mobile payment cardlets 306 may represent a respective payment card account belonging to the user and may store or have access to the corresponding payment card account number for the payment card account it represents. In many ways the mobile payment cardlets 306 may operate in a conventional manner in consummating payment transactions—however, as described further herein, the way that the payment data is provided to a merchant server 316 for use in completing a transaction is different depending on what data format the merchant server 316 supports.

As shown in FIG. 3, the secure element 304 may also store one or more client applets 308 which facilitate interaction with and retrieval of data from each of the payment cardlets 304. The mobile device 302 also stores one or more merchant applets 310 and payment applets 312. Each merchant applet 310, for example, may provide functionality to allow interaction with a merchant server 316. A merchant applet 310 may be configured for interaction with a specific merchant (having one or more merchant servers 316) or it may be configured to allow interaction with multiple merchants. For example, a merchant applet 310 may be part of or associated with a merchant application operating on the mobile device 102. The payment applet 312 may facilitate communication with a wallet server (such as payment server 314). For example, the payment applet 312 may be an application allowing interaction with a MasterPass wallet server operated by or on behalf of MasterCard International Incorporated, the assignee of the present application. Each of the applets 306, 308, 310, 312 interact during a payment transaction of the present invention to provide remote payment data in a format supported by the merchant server 316, allowing transactions to be securely conducted in a manner supported by the merchant server 316. The provision of the remote payment data will now be described by reference to FIG. 4. It will be appreciated that the payment cardlets 306 and the applets 308, 310 and 312 are software applications or applets and thus may be referred to as software entities. In some embodiments, the cardlets and applets may be created pursuant to the JavaCard specifications (e.g., such as those available at http:www.globalplatform.org, the contents of which are hereby incorporated by reference in their entirety for all purposes).

Pursuant to some embodiments, the cardlets may be personalized such that additional data may be returned in a response to a merchant transaction. For example, the Application PAN and Application PAN sequence number may be personalized such that they can be returned in a command response message.

FIG. 4 is a flow chart that illustrates a process that may be performed in the mobile device 102 according to aspects of the present invention. The process of FIG. 4 is commenced by a trigger event indicated by block 402 in FIG. 4. For example, a trigger event may occur if a user of the mobile device 102 interacts with the mobile device 102 to initiate a payment transaction. For example, the user may initiate a payment transaction by interacting with a merchant application on the mobile device 102 to select one or more goods or services to purchase and request that the transaction be initiated. As another example, the user may initiate a payment transaction by interacting with a Web browser on the mobile device 102 to select one or more goods or services to purchase and request that the transaction be initiated. Transactions may be initiated in a number of other manners as well.

Once the transaction is initiated, processing continues at 40 where the mobile device 102 (e.g., under control of the merchant applet 310, the payment applet 312 and/or the client applet 308) transmits a payment transaction initiation request message to a merchant server 106 associated with the merchant with whom the transaction is to be conducted. The payment transaction initiation request message may be transmitted over a network connection between the mobile device 102 and the merchant server 106.

Processing continues at 406 where the mobile device 102 receives information identifying a data format supported by the merchant server 106. For example, the merchant server 106 may indicate to the mobile device 102 whether it supports a first data format or an alternative data format for the transaction. In some embodiments, merchant servers 106 may support full EMV style transactions (e.g., as used herein, the “first data format” in which the mobile device is to transmit a cryptogram to the merchant server 106 in the full EMV format). In some embodiments, merchant servers 106 may not support full EMV style transactions (e.g., as used herein, the “alternative data format” in which the mobile device is to provide information allowing an entity to generate a cryptogram using a partial set of inputs and the message is not provided in the full EMV format). In some embodiments, the alternative data format may also be used to provide cardholder verification results. For example, as shown in Table 2, below, the alternative “Format 1” may provide cardholder verification result data in a data object labeled “Card Verification Results” computed using a script or PIN counter.

Once the mobile device 102 has received information indicating which data format is supported by the merchant server 106, processing continues at 408 where the mobile device 102 operates to provide remote payment data to the merchant server 106 in the supported data format.

If the merchant server 106 supports the first data format, the software of the mobile device 102 will be operated to provide remote payment data to the merchant server 106 using a cryptogram (such as the EMV Authentication Request Cryptogram (“ARQC”)) in the full EMV data format in Data Element 55 (as specified in the EMV specifications). The cryptogram may then be used by the merchant server 106 (and/or the payment gateway 108, the acquirer 110 or the issuer systems) to be validated using a standard EMV authorization host system.

If the merchant server 106 does not support the first data format (and, instead, supports an alternative data format), the cryptogram will be generated using a partial set of input data from the selected payment cardlet 306. In one specific illustrative example, the table below illustrates the data the payment cardlet 306 will provide as input to the remote payment cryptogram depending on whether the merchant server supports the first data format or an alternative data format.

TABLE 1

| Data Element | First Data Format | Alternative Data Format |
|---|---|---|
| Amount, Authorized | Take value from input | Default to zero |
| Amount, Other | command | |
| Transaction Currency | | |
| Code | | |
| Transaction Date | | |
| Terminal Country Code | Take value personalized | |
| Transaction Type | in cardlet | |
| Terminal Verification | Default to zero | |
| Results | | |

TABLE 2

| Data Element | Alt Format 0 | Alt Format 1 | Alt Format 2 |
|---|---|---|---|
| Amount, Authorized | Default to 0 | Default to 0 | Default to 0 |
| Amount, Other | Default to 0 | Default to 0 | Default to 0 |
| Terminal Country | Default to 0 | Default to 0 | Default to 0 |
| Code | | | |
| Terminal Verification | Default to 0 | Default to 0 | Default to 0 |
| Results | | | |
| Transaction Currency | Default to 0 | Default to 0 | Default to 0 |
| Code | | | |
| Transaction Date | Default to 0 | Default to 0 | Default to 0 |
| Transaction Type | Default to 0 | Default to 0 | Default to 0 |
| Unpredictable | As provided in | As provided in | As provided in |
| Number | input | input | input |
| Application | AIP | AIP | AIP |
| Interchange Protocol | | | |
| Application | Current value | Current value | Current value |
| Transaction Counter | | | |
| Card Verification | Mask | As computed | As computed |
| Results | | | |

As shown in Table 1, when the merchant server 106 supports the second data format, some of the data used to generate the remote payment cryptogram is defaulted to zero, while the data used to generate the remote payment cryptogram for the first data format takes the value from the input data (e.g., from the cardlet or the payment applet) or uses a value personalized in the secure element.

As shown in Table 2 and Table 4 (below), a number of different alternative data formats may be provided. For example, “Alt Format 0” may be used for transactions involving mobile devices with a secure element or for MCBP transactions. “Alt Format 1” may be used for transactions involving mobile devices with a secure element where counter information has to be carried as part of the authorization transaction. “Alt Format 2” may be used for transactions involving MCBP transactions which also benefit from, or require information about user consent or user authentication (referred to as “CDCVM” data) to the issuer or payment network.

In some embodiments, when the merchant server 106 supports data in the first data format, the remote payment data is returned to the merchant server 106 in an ISO “format 2” response and the data object returned in the response message is a constructed data object with a tag equal to “ABC”. The value field contains several Basic Encoding Rules tag, length, value (“BER-TLV”) coded data objects. For example, the content of the “ABC” part of the input to the transaction for a first data element transaction is shown below in Table 2.

TABLE 3

| Tag | Data Object |
|---|---|
| ‘9F09’ | Application Version Number (Reader) |
| ‘9F33’ | Terminal Capabilities |
| ‘9F53’ | Transaction Category Code |
| ‘6F’ | DF Name |
| ‘5A’ | Application PAN |
| ‘5F34’ | Application Sequence Number |
| ‘57’ | Track 2 Equivalent Data |
| ‘5F24’ | Application Expiration Date |
| ‘9C’ | Terminal Type |
| ‘9F1A’ | Terminal Country Code |
| ‘9C’ | Transaction Type |
| ‘9A’ | Transaction Date |
| ‘95’ | Terminal Verification Results |
| ‘9F27’ | Cryptogram Information Data (CID) |
| ‘9F34’ | CVM results |
| ‘82’ | Application Interchange Profile (AIP) |
| ‘9F36’ | Application Transaction Counter (ATC) |
| ‘9F26’ | Application Cryptogram |
| ‘9F10’ | Issuer Application Data |
| ‘9F37’ | Unpredictable Number |
| ‘9F02’ | Amount, Authorized (Numeric) |
| ‘9F03’ | Amount, Other (numeric) |
| ‘5F2A’ | Transaction Currency Code |

In some embodiments, when the merchant server 106 supports data in an alternative data format, the remote payment data is returned to the merchant server 106 in the equivalent of an ISO “format 1” response and the data object returned in the response message is a primitive data object with tag equal to “DEF”. The value field consists of the concatenation without delimiters (tag and length) of the value fields of the data objects as shown below in Table 3. Pursuant to some embodiments, the Application Cryptogram field of Table 3 may be used to store one or two cryptograms. For example, in some embodiments, an implementation associated with a secure element which requires one cryptogram may be supported as well as implementations which use one or two cryptograms (such as implementations without secure elements such as a cloud based payments system).

TABLE 4

| | Value | | |
|---|---|---|---|
| Data Object | Alt Format 0 | Alt Format 1 | Alt Format 2 |
| Version / UCAF PAN | As computed | As computed | As computed |
| Sequence # | | | |
| Application | ARQC as | ARQC as | ARQC as |
| Cryptogram | computed | computed | computed |
| Application | Current value | Current value | Current Value |
| Transaction Counter | | | |
| Unpredictable Number | As provided in | As provided in | As provided in |
| | input | input | input |
| Application | As personalized | As personalized | As personalized |
| Interchange Protocol | | | |
| Key derivation index | As personalized | As personalized | As personalized |
| (KDI) | | | |
| Cryptogram Version | As computed | As computed | As computed |
| Number (CVN) | | | |
| Script Counter / PIN | — | Current values | — |
| Try Counter | | computed for | |
| | | transaction | |
| Limits Exceeded | — | Current values | — |
| | | computed for | |
| | | transaction | |
| CDCVM Data | — | — | As computed |

Pursuant to some embodiments, in the case that the merchant server 106 supports an alternative data format, the ARQC is generated using a partial set of the inputs available (as shown in Table 1 above). The ARQC and associated EMV data is compressed and packaged in a field of a standard ISO payment authorization request message (e.g., in the UCAF field). The data is provided the merchant server 106 for processing. In some embodiments, the merchant server 106 generates an authorization request for transmission to the payment network as follows. The authorization request is submitted with the “Point of Service Entry Mode” (DE 22 SF1) set to “81” (indicating an entry mode of “e-commerce including chip”). The e-commerce indicators are set to: (1) Subfield 1 (Electronic Commerce Security Level Indicator and UCAF Collection Indicator) is set to a value of “212” with the following values (i) Position 1 (Security Protocol) set to “2” (“channel”), (ii) Position 2 (Cardholder Authentication) is set to “1” (cardholder certificate not used), (iii) Position 3 (UCAF Collection Indicator) is set to “2” (UCAF data collection is supported by the merchant, and UCAF data must be present), (2) the cryptogram is contained in the DE 48 SE 43 field (also known as the UCAF field).

Continuing the description of processing of an alternative data format transaction, once the remote payment data is generated by the cardlets and applets of the mobile device 102, the data is transmitted to the merchant applet 310 for transmission to the merchant server 106. The merchant server 106 (possibly via a merchant payment gateway) packages the remote payment data in an authorization request for transmission to an acquirer 110. The authorization request, response and clearing will be processed between the merchant server 106 (or gateway 108), the payment server 104, and the issuer. These transactions are mapped by the payment server. For an alternative data format transaction, the payment server (or other entity) rebuilds the alternative data format message into a first data format message. The rebuilding may consist of adding a tag length to the data received in the UCAF field, adding the defaulted data (of Table 1) to recreate a first data format message, and extracting the PAN from the message and adding it to the first data format (as item ‘5A’ and item ‘5F34’ of Table 2). In this way, a merchant that supports only an alternative data format can enjoy the benefits of transactions conducted using the first data format.

Aspects of the invention have been described above in the context of a mobile device such as a mobile telephone. However, the principles of the present invention are equally applicable to other types of devices, including tablet computers, or other computing devices.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

The flow charts and descriptions thereof herein should not be understood to prescribe a fixed order of performing the method steps described therein. Rather the method steps may be performed in any order that is practicable.

As used herein and in the appended claims, the term “payment card account” or “payment device” includes a credit card account or a deposit account that the account holder may access using a debit card. The term “payment card account number” includes a number that identifies a payment card system account or a number carried by a payment card, or a number that is used to route a transaction in a payment system that handles debit card and/or credit card transactions. The term “payment card” includes a credit card or a debit card or other payment device.

As used herein and in the appended claims, the term “payment card system” refers to a system for handling purchase transactions and related transactions. An example of such a system is the one operated by MasterCard International Incorporated, the assignee of the present disclosure. In some embodiments, the term “payment card system” may be limited to systems in which member financial institutions issue payment card accounts to individuals, businesses and/or other organizations.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method for operating a payment-enabled mobile device to facilitate a payment transaction with a merchant server, comprising:
receiving, by a mobile device processor of a payment-enabled mobile device via an input/output device from a user, a payment transaction request associated with purchasing at least one of a good or a service from a merchant;
transmitting, in response to the payment transaction request by the mobile device processor via receive/transmit circuitry, a payment transaction initiation message directly to a merchant server of the merchant;
receiving, by the mobile device processor via the receive/transmit circuitry from the merchant server, a request message comprising one of a request to provide an Authorization Request Cryptogram (ARQC) pursuant to EMV standards or a request to provide user consent information including cardholder verification results or a request to provide an ARQC generated by using a partial set of data inputs;
determining, by the mobile device processor based on the received request message, a particular mobile payment cardlet to utilize from a plurality of mobile payment cardlets available in a secure element of the payment-enabled mobile device;
generating, by the mobile device processor using the particular mobile payment cardlet, remote payment data; and
transmitting, by the mobile device processor via the receive/transmit circuitry, the remote payment data to the merchant server to process the payment transaction.

2. The method of claim 1, further comprising:
packaging, by the merchant server, the remote payment data in an authorization response; and
transmitting, by the merchant server, the authorization response to an acquirer financial institution.

3. The method of claim 1, wherein the partial set of data inputs includes at least a first data field set to a default value.

4. The method of claim 3, wherein the default value is zero.

5. The method of claim 1, wherein the mobile payment cardlet is personalized such that at least an Application Primary Account Number (PAN) and an Application PAN sequence number are returned in a command response.

6. A payment-enabled mobile device operable to facilitate a payment transaction with a merchant server, comprising:
an input/output device;
receive/transmit circuitry;
a memory;
a secure element; and
a mobile device processor operably connected to the input/output device, to the receive/transmit circuitry, to the memory and to the secure element, wherein the memory stores processor executable instructions which when executed cause the mobile device processor to:
receive a payment transaction request via the input/output device from a user of the payment-enabled mobile device, the payment transaction request associated with purchasing at least one of a good or a service from a merchant;
transmit, in response to the payment transaction request via the receive/transmit circuitry, a payment transaction initiation message directly to a merchant server of the merchant;
receive, via the receive/transmit circuitry from the merchant server, a request message comprising one of an Authorization Request Cryptogram (ARQC) pursuant to EMV standards or user consent information including cardholder verification results or an ARQC generated by using a partial set of data inputs;
determine, based on the received request message, a particular mobile payment cardlet to utilize from a plurality of mobile payment cardlets available in a secure element of the payment-enabled mobile device;
generate, using the particular mobile payment cardlet, remote payment data; and
transmit, via the receive/transmit circuitry, the remote payment data to the merchant server.

7. The apparatus of claim 6, wherein the partial set of data inputs include at least a first data field that is set to a default value.

8. The apparatus of claim 7, wherein the default value is zero.

9. The apparatus of claim 6, wherein the payment cardlet is personalized such that an Application Primary Account Number (PAN) and an Application PAN sequence number are returned in a command response.

10. A system for facilitating a payment transaction between a payment-enabled mobile device of a user and a merchant server comprising:
a merchant server;
a payment server; and
a payment-enabled mobile device operably connected to the merchant server and to the payment server, the payment-enabled mobile device comprising a mobile device processor operably connected to an input/output device, receive/transmit circuitry, a memory, and a secure element, wherein the memory stores processor executable instructions which when executed cause the mobile device processor to:
receive a payment transaction request via the input/output device from a user of the payment-enabled mobile device, the payment transaction request associated with purchasing at least one of a good or a service from a merchant;
transmit, in response to the payment transaction request via the receive/transmit circuitry, a payment transaction initiation message directly to a merchant server of the merchant;
receive, via the receive/transmit circuitry from the merchant server, a request message comprising one of an Authorization Request Cryptogram (ARQC) pursuant to EMV standards or user consent information including cardholder verification results or an ARQC generated by using a partial set of data inputs;
determine, based on the received request message, a particular mobile payment cardlet to utilize from a plurality of mobile payment cardlets available in a secure element of the payment-enabled mobile device;
generate, using the particular mobile payment cardlet, remote payment data; and
transmit, via the receive/transmit circuitry, the remote payment data to the merchant server.

11. The system of claim 10, further comprising:
a payment gateway operably connected to the merchant server; and
an acquirer financial institution (FI) operably connected to the payment gateway;
and wherein the merchant server is configured to:
package the remote payment data in an authorization response; and
transmit the authorization response to the acquirer FI via the payment gateway.

12. The system of claim 10, wherein the partial set of data inputs include at least a first data field that is set to a default value.

13. The system of claim 12, wherein the default value is zero.

14. The system of claim 10, wherein the payment cardlet is personalized such that an Application Primary Account Number (PAN) and an Application PAN sequence number are returned in a command response.
